(19) United States
(12) Patent Application Publication
(10) Pub. No.: US 2007/0022242 A1
(43) Pub. Date: Jan. 25, 2007

(54) [STRUCTURE OF ACCESS OF NAND FLASH MEMORY]

(75) Inventor: Kuo-Yi Cheng, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., Chutung Town, Hsinchu Hsien (TW)

(21) Appl. No.: 11/161,020

(22) Filed: Jul. 20, 2005

(51) Int. Cl. G06F 12/00; G06F 13/00

(52) U.S. Cl. 711/103; 711/167

(57) ABSTRACT

A structure of an access of a NAND flash memory, for randomly accessing said NAND flash memory is provided. The access of the NAND flash memory comprises a direct access interface having an asynchronous read mode, an asynchronous write mode, a synchronous read mode and a synchronous write mode for accessing data; a register connected to said direct access interface and compatible with a ATA interface; a data buffer connected to the direct access interface; a NAND flash memory access interface connected to the register and the data buffer respectively; and a NAND flash memory connected to the NAND flash memory access interface, wherein commands compatible with ATA interface are used to randomly access said NAND flash memory via said ATA interface.

### BACKGROUND OF THE INVENTION

1. The field of the invention

The present invention is related to a structure of an access of a NAND flash memory, and more particularly, to a structure of an access of the NAND flash memory for randomly accessing the NAND flash memory. The access comprises a direct access interface for transmission and a register compatible with ATA interface to enable the microprocessor to control the register through a direct, asynchronous location targeting method, and use ATA interface command to randomly store into/retrieve from the NAND flash memory.

2. Description of related art

In recent years, portable devices are widely used, a variety of applications of the portable devices are also corresponding increasing as well. The portable device is being upgraded from earlier electronic notebook to documentation and database management tools. With the well-developed technology and the advanced skills, the host originally designed to provide services to fixed devices are now capable of extending various services to portable devices such as positioning electronic maps generated by the GPS, audio-video media, and the like. Such services attracted users to use the portable devices. However, for enjoying these services, larger memory capacity is highly demanded. However, large memory capacity limits the portable device from meeting the present trend of being lighter, thinner, shorter and smaller. Thus, many manufacturers turned to develop the flash memory to resolve this problem.

Flash memory is popular for its advantageous characteristics, such as non-volatility, shock proof, high density, and the like. Among many portable devices, the flash memory has replaced the EEPROM or the memory, which requires battery. Because the semiconductor technology is mature, it is possible to increase both storage density and transmission speed of the flash memory. Therefore, flash memory has gradually replaced the conventional storage media, such as the hard disk driver.

Nowadays, there are various types of flash memory available on the market, for example, NOR, NAND and AND, which are classified according to the differences in memory unit and the arrangement of the control line. The differences affect the size of the erase segments and the operation speed. Because of the smaller size, larger capacity and high speed of NAND flash memory; it has become the most popular type of memory on the market. However, the NAND has the disadvantage of complicated access and management procedures, in that, the conventional NAND flash memory cannot be randomly accessed. Therefore, the application of NAND flash memory is only suitable processing large quantity of data.

Accordingly, manufacturers use NAND flash memory and NOR flash memory together to serve as memory unit controller. Besides, the manufacturers have setup their own commands to operate the microprocessor for randomly accessing the NAND flash memory. Nevertheless, the users are required to learn the brand-new commands programmed by the manufactures to implement the application of the NAND flash memory on the system. This not only cause inconvenience to the users but problems due to errors created by the users who are not familiar with the new commands. Thus, the system could be unstable may loose data when the errors occurred are serious.

The current interface in the disk driver is an ATA interface, which specified by the American National Standard Institution (ANSI). The specification has ATA-1 up to ATA-5, and the ATA interface is an essential interface for every computers. Few years ago, some manufacturers have tried to install the ATA interface into the system chip. Obviously, the ATA interface is a well-known to programmers and users and easy to operate interface.

Therefore, how to randomly access the NAND flash memory has become a very important issue to the manufacturers in the field.

### SUMMARY OF THE INVENTION

Accordingly, in the view of the foregoing, the present inventor makes a detailed study of related art to evaluate and consider, and uses years of accumulated experience in this field, and through several experiments, to create a structure of an access of a NAND flash memory.

According to an aspect of the present invention, a direct access interface and a register compatible with the ATA interface are provided to enable the microprocessor to control the register via a direct asynchronous location targeting method, and use command of the ATA interface to randomly access the NAND flash memory to store to/retrieve from the NAND flash memory.

According to another aspect of the present invention, commands of the ATA interface, which programmers and users are familiar with, are used to operate the NAND flash memory. Thus, programming time can be effectively reduced, and also the stability of the whole system can be effectively promoted. Thus, the overall cost of the can be effectively reduced. dr

### DESCRIPTION OF THE DRAWING

For a more complete understanding of the present invention, reference will now be made to the following detailed description of preferred embodiments taken in conjunction with the following accompanying drawings.

FIG. 1 is a block diagram of a structure of random access of a flash memory according to an embodiment of the present invention.

FIG. 2 illustrates an asynchronous read mode according to an embodiment of the present invention.

FIG. 3 illustrates an asynchronous write mode according to an embodiment of the present invention.

FIG. 4 illustrates a synchronized read mode according to an embodiment of the present invention.

FIG. 5 illustrates a synchronized write mode according to an embodiment of the present invention.

FIG. 6 illustrates a flowchart of a process of executing reading process according to an embodiment of the present invention.

FIG. 7 illustrates a register setting table for executing reading according to an embodiment of the present invention.

FIG. 8 illustrates a flowchart of a process for executing writing process according to an embodiment of the present invention.

FIG. 9 illustrates a register setting table for executing writing according to an embodiment of the present invention.

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

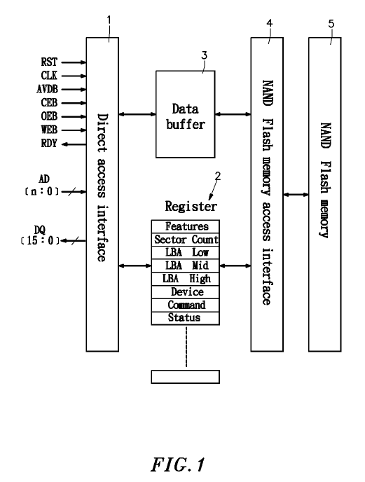

Referring to FIG. 1, the present invention comprises a direct access interface 1, a register 2, a data buffer 3, a NAND flash memory access interface 4 and a NAND flash memory 5.

According to an embodiment of the present invention, different types of direct access interface 1, such as asynchronous read mode, asynchronous write mode, synchronous read mode and synchronous write mode are provided.

The register 2 is connected to the direct access interface 1 and comprises registers compatible with the ATA interface. For instance, the feature register, the sector count register, the LBA low register, the LBA mid register, the LBA high register, the device register, the command register and the status register.

The data buffer 3 is directly connected to the direct access interface 1.

The NAND flash memory access interface 4 is connected to the register 2 and the data buffer 3 respectively.

The NAND flash memory 5 is connected to the NAND flash memory access interface 4.

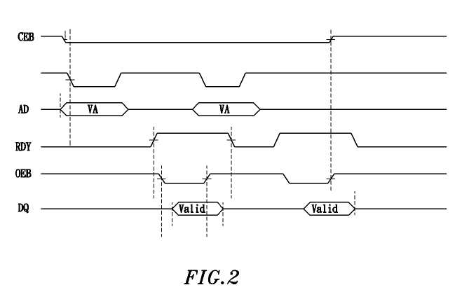

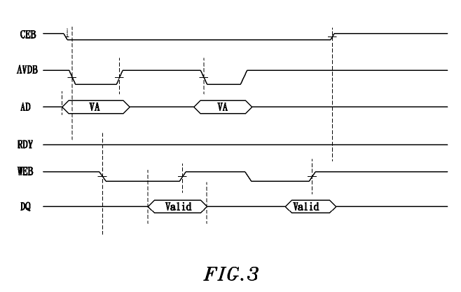

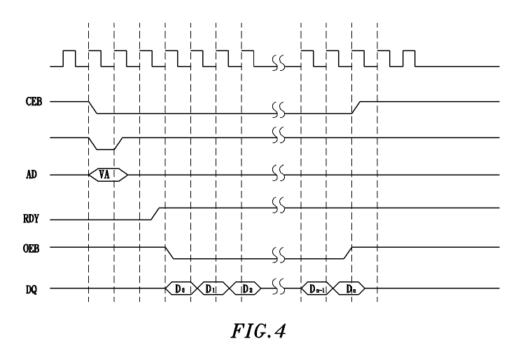

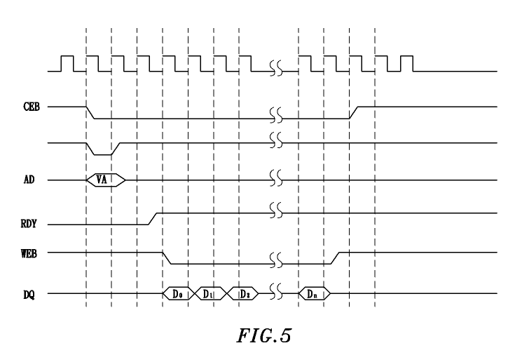

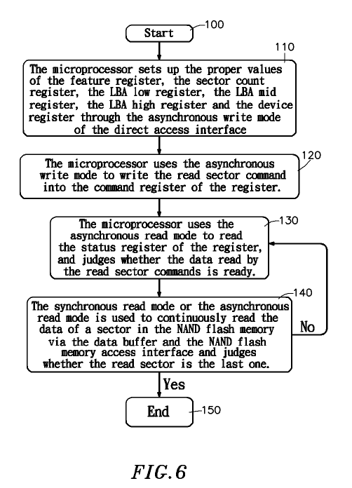

Referring to FIGS. 1, 2, 3, 4, 5, 6 and 7, when a microprocessor commands to the read sector compatible with the ATA interface to access for reading data in the NAND flash memory 5, the reading procedure is as follows:

at step 100, the process is started;

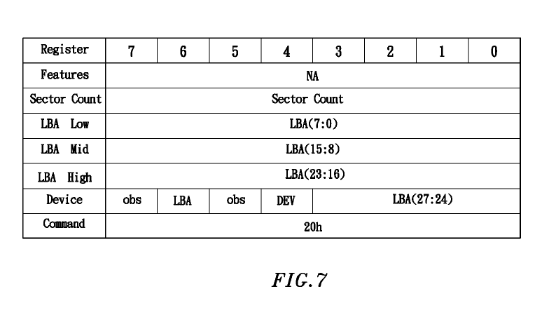

at step 110, the microprocessor sets up the proper values of the feature register, the sector count register, the LBA low register, the LBA mid register, the LBA high register and the device register through the asynchronous write mode of the direct access interface 1, as shown in FIG. 7;

at step 120, the microprocessor uses the asynchronous write mode to write the read sector command into the command register of the register 2;

at step 130, the microprocessor uses the asynchronous read mode to read the status register of the register 2, and judges whether the data read by the read sector commands is ready, if yes, the process proceeds to step 140;

at step 140, the synchronous read mode or the asynchronous read mode is used to continuously read the data of a sector in the NAND flash memory 5 via the data buffer 3 and the NAND flash memory access interface 4, and judges whether the read sector is the last one; if yes, then the process proceeds to step 150, otherwise the process proceeds to step 130; and

at step 150, the process ends.

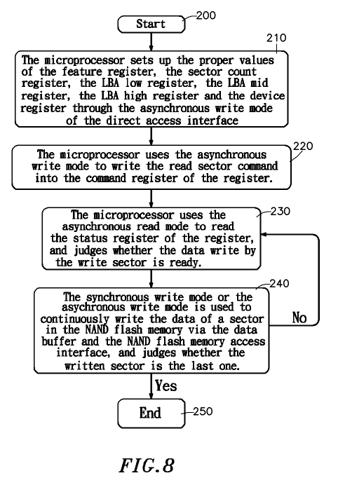

Referring to FIGS. 1, 2, 3, 4, 5, 8 and 9, when a microprocessor commands to the write sector compatible with the ATA interface to access for writing data in the NAND flash memory 5, the writing procedure is as follows:

at step 200, the process is started;

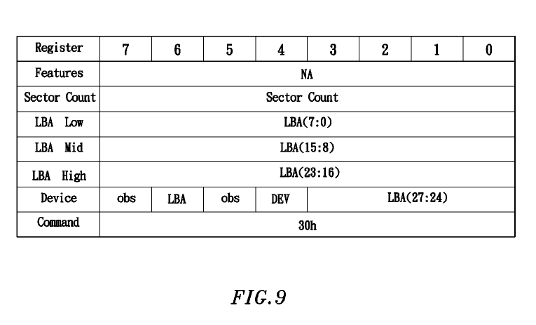

at step 210, the microprocessor sets up the proper values of the feature register, the sector count register, the LBA low register, the LBA mid register, the LBA high register and the device register through the asynchronous write mode of the direct access interface 1, as shown in FIG. 9;

at step 220, the microprocessor uses the asynchronous write mode to write the write sector command into the command register of the register 2;

at step 230, the microprocessor uses the asynchronous read mode to read the status register of the register 2, and judges whether the data write by the write sector command is ready, if yes, the process proceeds to step 240;

at step 240, the synchronous write mode or asynchronous write mode is used to continuously write the data of a sector in the NAND flash memory 5 via the data buffer 3 and the NAND flash memory access interface 4, and judges whether the written sector is the last one; if yes, then the process proceeds to step 250, otherwise the process proceeds to step 230; and

at step 250, the process ends.

As described above, the write sector command and the read sector command compatible with the ATA interface may be readily applied to randomly access the NAND flash memory 5, and the synchronous read mode and the synchronous write mode may be applied by the NAND flash memory 5 to continuously handle the data. Furthermore, the asynchronous read mode and the asynchronous write mode may also be applied by the NAND flash memory 5.

Furthermore, other commands compatible with the ATA interface may also applied to control the flash memory by using the control process described in ATA specification.

Therefore, the structure of the access of the NAND flash memory according to the present invention provides the following advantages. The transmission method provided by the direct access interface and the register compatible with the ATA interface enable the microprocessor to randomly access to the NAND by controlling the register through the asynchronous direct location targeting method. Thus, the disadvantage of the conventional NAND not being randomly accessed can be effectively resolved. According to an embodiment of the present invention, to randomly access the NAND flash memory, the command of the ATA interface is applied, the data may be stored in the buffer, and then accessed through either synchronously or asynchronously method. Thus, the data can be readily accessed. Furthermore, because programmers and users are familiar with the ATA interface and its operations, and therefore not only the time consumption for designing program is reduced but also the stability of the whole system can be promoted. Thus, overall cost can be reduced.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A structure of an access of a NAND flash memory, for randomly accessing said NAND flash memory, comprising:
a direct access interface, comprising an asynchronous read mode, an asynchronous write mode, a synchronous read mode and a synchronous write mode for accessing data;
a register, connected to said direct access interface and compatible with a ATA interface;
a data buffer, connected to said direct access interface;
a NAND flash memory access interface, connected to said register and said data buffer respectively; and
a NAND flash memory, connected to NAND flash memory access interface, wherein commands compatible with ATA interface are used to randomly access said NAND flash memory.

2. The structure of an access of a NAND flash memory according to claim 1, wherein said register comprises a feature register, a sector count register, a LBA low register, a LBA mid register, a LBA high register, a Device register, a command register and a Status register that are compatible with said ATA interface.

3. A structure of an access of a NAND flash memory, comprising a direct access interface connected to a data buffer and a register compatible with a ATA interface respectively, said data buffer and said register are connected to a NAND flash memory access interface, and said NAND flash memory access interface is connected to a NAND flash memory, the structure of the access capable of implementing a method of reading data from said NAND flash memory comprising:
(a) starting the process;
(b) a microprocessor setting up the values of a feature register, a sector count register, a LBA low register, a LBA mid register, a LBA high register and a device register through an asynchronous write mode of said direct access interface;
(c) using said asynchronous write mode to write a read sector command into a command register of said register;
(d) using an asynchronous read mode to read a status register of said register, and judging whether a data read by the read sector command is ready, if yes, proceeding to step (e);
(e) using a synchronous read mode or a asynchronous read mode to continuously read said data of a sector in said NAND flash memory via said data buffer and said NAND flash memory access interface, and judging whether said read sector is a last one; if yes, proceeding to step (f);
(f) ending.

4. The structure of an access of a NAND flash memory according to claim 3, wherein if said read sector is not a last one, then process proceeds to step (d).

5. A structure of an access of a NAND flash memory, comprising a direct access interface connected to a data buffer and a register compatible with a ATA interface respectively, said data buffer and said register are connected to a NAND flash memory access interface, and said NAND flash memory access interface is connected to a NAND flash memory, the structure of the access capable of implementing a method of writing data to said NAND flash memory comprising:
(a) starting the process;
(b) a microprocessor setting up the values of a feature register, a sector count register, a LBA low register, a LBA mid register, a LBA high register and a device register through an asynchronous write mode of said direct access interface;
(c) using said asynchronous write mode to write a write sector command into a command register of said register;
(d) using an asynchronous read mode to read a status register of said register, and judging whether a data write by the write sector command is ready, if yes, proceeding to step (e); and
(e) using a synchronous write mode or a asynchronous write mode to continuously write said data of a sector in said NAND flash memory via said data buffer and said NAND flash memory access interface, and judging whether said read sector is a last one; if yes, proceeding to step (f); and
(f) ending.

6. The structure of an access of a NAND flash memory according to claim 5, wherein if said read sector is not a last one, then process proceeds to step (d).
